(19) United States
(12) Patent Application Publication
(10) Pub. No.: US 2021/0356781 A1
(43) Pub. Date: Nov. 18, 2021

(54) LIQUID CRYSTAL DISPLAY MOTHERBOARD STRUCTURE AND CUTTING METHOD THEREOF

(71) Applicant: SHENZHEN CHINA STAR OPTOELECTRONICS SEMICONDUCTOR DISPLAY TECHNOLOGY CO., LTD., Shenzhen (CN)

(72) Inventor: Kaijun WANG, Shenzhen (CN)

(73) Assignee: SHENZHEN CHINA STAR OPTOELECTRONICS SEMICONDUCTOR DISPLAY TECHNOLOGY CO., LTD., Shenzhen (CN)

(21) Appl. No.: 16/617,512

(22) PCT Filed: Aug. 23, 2019
(86) PCT No.: PCT/CN2019/102243

§ 371 Date: Nov. 27, 2019

(30) Foreign Application Priority Data
May 26, 2019 (CN) 201910451233.6

(51) Int. Cl. G02F 1/1339; G02F 1/1335; G02F 1/1333

(52) U.S. Cl. CPC G02F 1/1339; G02F 1/133514; G02F 1/133302; G02F 1/133351; G02F 1/133305

(57) ABSTRACT

A liquid crystal display (LCD) motherboard structure and a cutting method thereof are provided. The LCD motherboard structure includes a flexible display motherboard. The flexible display motherboard includes a plurality of display panels. The display panels include a plurality of corresponding first sealants for bonding a plurality of color filter substrates and a plurality of array substrates. The flexible display motherboard is provided with a corresponding set of die cutting lines for each display panel. An orthographic projection of a corresponding portion of each set of die cutting lines on a plane where the display panels are located is located inside an orthographic projection of the corresponding first sealant on the plane where the display panels are located.

### FIELD OF INVENTION

The present disclosure relates to a technical field of displays, and more particularly to a liquid crystal display (LCD) motherboard structure and a cutting method thereof.

### BACKGROUND OF INVENTION

Flexible organic light-emitting diode (OLED) panels will be mass-produced. At the same time, research and development of flexible liquid crystal display (LCD) devices have also emerged in the industry. A flexible LCD device manufacturing process generally includes: forming a plurality of corresponding film layers on a plurality of corresponding flexible substrates on a plurality of rigid substrates, to form a color filter substrate and an array substrate; then, assembling the array substrate and the color filter substrate; then, performing a peeling process on a motherboard, to separate the rigid substrates from the motherboard; and finally, cutting the motherboard into a plurality of flexible display panels, bonding a corresponding flexible printed circuit board to each flexible display panel, and performing polarizer film attachment.

Currently, a main way to separate the rigid substrates from the motherboard is laser separation. However, energy generated by laser separation causes the corresponding flexible substrates of the motherboard to be stressed to curl toward sides of the rigid substrates. This type of curl not only affects uniformity during laser separation, but also causes polarizer film attachment and a bonding process to be impossible.

### SUMMARY OF INVENTION

Some embodiments of the present disclosure provide a liquid crystal display (LCD) motherboard structure and a cutting method thereof, to solve a technical problem that for an existing LCD panel, using laser to separate a plurality of rigid substrates from a motherboard may easily cause a plurality of corresponding flexible substrates of the motherboard to curl.

Some embodiments of the present disclosure provide an LCD motherboard structure, including: a flexible display motherboard, and a first rigid substrate and a second rigid substrate disposed on two sides of the flexible display motherboard, wherein the flexible display motherboard comprises a plurality of display panels;

wherein the display panels comprise a plurality of corresponding first sealants for bonding a plurality of corresponding color filter substrates and a plurality of corresponding array substrates; and the flexible display motherboard is provided with a corresponding set of die cutting lines for cutting to form each single display panel of the display panels;

wherein an orthographic projection of a corresponding portion of each set of die cutting lines on a plane where the display panels are located is located inside an orthographic projection of the corresponding first sealant on the plane where the display panels are located;

wherein each display panel comprises a corresponding bonding area; each first sealant comprises a corresponding first sub-sealant, a corresponding second sub-sealant, a corresponding third sub-sealant, and a corresponding fourth sub-sealant; each first sub-sealant is close to the corresponding bonding area; each second sub-sealant is opposite to the corresponding first sub-sealant; each third sub-sealant connects the corresponding first sub-sealant to the corresponding second sub-sealant on a same side of the corresponding first sub-sealant and the corresponding second sub-sealant; and each fourth sub-sealant is opposite to the corresponding third sub-sealant;

wherein each set of die cutting lines comprises a corresponding first sub-cutting line, a corresponding second sub-cutting line, a corresponding third sub-cutting line, and a corresponding fourth sub-cutting line; each first sub-cutting line is close to the corresponding bonding area; and each second sub-cutting line, each third sub-cutting line, and each fourth sub-cutting line are correspondingly disposed corresponding to the corresponding second sub-sealant, the corresponding third sub-sealant, and the corresponding fourth sub-sealant;

wherein an orthographic projection of each first sub-cutting line on the plane where the display panels are located is located outside an orthographic projection of the corresponding first sub-sealant on the plane where the display panels are located;

wherein an orthographic projection of each second sub-cutting line on the plane where the display panels are located is located inside an orthographic projection of the corresponding second sub-sealant on the plane where the display panels are located;

wherein an orthographic projection of a corresponding portion of each third sub-cutting line corresponding to the corresponding third sub-sealant on the plane where the display panels are located is located inside an orthographic projection of the corresponding third sub-sealant on the plane where the display panels are located;

wherein an orthographic projection of a corresponding portion of each fourth sub-cutting line corresponding to the corresponding fourth sub-sealant on the plane where the display panels are located is located inside an orthographic projection of the corresponding fourth sub-sealant on the plane where the display panels are located;

wherein the flexible display motherboard is provided with a set of peripheral cutting lines; the set of peripheral cutting lines divides the flexible display motherboard into a peripheral area and an internal area for the display panels to be disposed therein; and the peripheral area is disposed surrounding the internal area; and

wherein the flexible display motherboard further comprises a second sealant; and an orthographic projection of the set of peripheral cutting lines on the plane where the flexible display motherboard is located is located inside an orthographic projection of the second sealant on the plane where the flexible display motherboard is located.

In the LCD motherboard structure of the present disclosure, each second sub-cutting line divides the corresponding second sub-sealant into a corresponding second outer sub-sealant and a corresponding second inner sub-sealant; each third sub-cutting line divides the corresponding third sub-sealant into a corresponding third outer sub-sealant and a corresponding third inner sub-sealant; and each fourth sub-cutting line divides the corresponding fourth sub-sealant into a corresponding fourth outer sub-sealant and a corresponding fourth inner sub-sealant; and

wherein all of the second outer sub-sealants, the third outer sub-sealants, and the fourth outer sub-sealants have a first predetermined width; and the second inner sub-sealants, the third inner sub-sealants, and the fourth inner sub-sealants have a plurality of corresponding widths all larger than the first predetermined width.

In the LCD motherboard structure of the present disclosure, the flexible display motherboard is provided with a corresponding bonding area cutting line for cutting to form the corresponding bonding area of the corresponding array substrate of each display panel; and each third sealant is disposed between the corresponding bonding area cutting line and the corresponding first sub-cutting line.

In the LCD motherboard structure of the present disclosure, each display panel is further provided, on a side of the corresponding color filter substrate of each display panel, with a corresponding edge cutting line; and the corresponding edge cutting line is for removing a corresponding portion of the corresponding single color filter substrate of each display panel corresponding to the corresponding bonding area, to expose the corresponding bonding area.

Some embodiments of the present disclosure also provide an LCD motherboard structure, including: a flexible display motherboard, and a first rigid substrate and a second rigid substrate disposed on two sides of the flexible display motherboard, wherein the flexible display motherboard comprises a plurality of display panels;

wherein the display panels comprise a plurality of corresponding first sealants for bonding a plurality of corresponding color filter substrates and a plurality of corresponding array substrates; and the flexible display motherboard is provided with a corresponding set of die cutting lines for cutting to form each single display panel of the display panels;

wherein an orthographic projection of a corresponding portion of each set of die cutting lines on a plane where the display panels are located is located inside an orthographic projection of the corresponding first sealant on the plane where the display panels are located.

In the LCD motherboard structure of the present disclosure, each display panel comprises a corresponding bonding area; each first sealant comprises a corresponding first sub-sealant, a corresponding second sub-sealant, a corresponding third sub-sealant, and a corresponding fourth sub-sealant; each first sub-sealant is close to the corresponding bonding area; each second sub-sealant is opposite to the corresponding first sub-sealant; each third sub-sealant connects the corresponding first sub-sealant to the corresponding second sub-sealant on a same side of the corresponding first sub-sealant and the corresponding second sub-sealant; and each fourth sub-sealant is opposite to the corresponding third sub-sealant;

wherein each set of die cutting lines comprises a corresponding first sub-cutting line, a corresponding second sub-cutting line, a corresponding third sub-cutting line, and a corresponding fourth sub-cutting line; each first sub-cutting line is close to the corresponding bonding area; and each second sub-cutting line, each third sub-cutting line, and each fourth sub-cutting line are correspondingly disposed corresponding to the corresponding second sub-sealant, the corresponding third sub-sealant, and the corresponding fourth sub-sealant;

wherein an orthographic projection of each first sub-cutting line on the plane where the display panels are located is located outside an orthographic projection of the corresponding first sub-sealant on the plane where the display panels are located;

wherein an orthographic projection of each second sub-cutting line on the plane where the display panels are located is located inside an orthographic projection of the corresponding second sub-sealant on the plane where the display panels are located;

wherein an orthographic projection of a corresponding portion of each third sub-cutting line corresponding to the corresponding third sub-sealant on the plane where the display panels are located is located inside an orthographic projection of the corresponding third sub-sealant on the plane where the display panels are located; and

wherein an orthographic projection of a corresponding portion of each fourth sub-cutting line corresponding to the corresponding fourth sub-sealant on the plane where the display panels are located is located inside an orthographic projection of the corresponding fourth sub-sealant on the plane where the display panels are located.

In the LCD motherboard structure of the present disclosure, each second sub-cutting line divides the corresponding second sub-sealant into a corresponding second outer sub-sealant and a corresponding second inner sub-sealant; each third sub-cutting line divides the corresponding third sub-sealant into a corresponding third outer sub-sealant and a corresponding third inner sub-sealant; and each fourth sub-cutting line divides the corresponding fourth sub-sealant into a corresponding fourth outer sub-sealant and a corresponding fourth inner sub-sealant; and

wherein all of the second outer sub-sealants, the third outer sub-sealants, and the fourth outer sub-sealants have a first predetermined width; and the second inner sub-sealants, the third inner sub-sealants, and the fourth inner sub-sealants have a plurality of corresponding widths all larger than the first predetermined width.

A width of each first sealant is between 1 cm and 2.5 cm. The first predetermined width is between 0.1 cm and 0.8 cm. Optionally, the width of each first sealant is between 1.8 cm and 2.5 cm. The first predetermined width is between 0.1 cm and 0.5 cm. In this way, enough sealant may be ensured for each flexible LCD panel, so that subsequent bending does not easily cause separation. Further, stress cancellation of each of a plurality of upper flexible substrates and a corresponding lower flexible substrate of a plurality of lower flexible substrates is better controlled because a corresponding set of panel edges of a plurality of sets of panel edges and a corresponding set of sealant edges of a plurality of sets of sealant edges being flat and aligned after cutting using a laser is ensured.

In the LCD motherboard structure of the present disclosure, the flexible display motherboard is provided with a corresponding bonding area cutting line for cutting to form the corresponding bonding area of the corresponding array substrate of each display panel; and each third sealant is disposed between the corresponding bonding area cutting line and the corresponding first sub-cutting line.

In the LCD motherboard structure of the present disclosure, each display panel is further provided, on a side of the corresponding color filter substrate of each display panel, with a corresponding edge cutting line; and the corresponding edge cutting line is for removing a corresponding portion of the corresponding single color filter substrate of each display panel corresponding to the corresponding bonding area, to expose the corresponding bonding area.

In the LCD motherboard structure of the present disclosure, the flexible display motherboard is provided with a set of peripheral cutting lines; the set of peripheral cutting lines divides the flexible display motherboard into a peripheral area and an internal area for the display panels to be disposed therein; and the peripheral area is disposed surrounding the internal area; and

wherein the flexible display motherboard further comprises a second sealant; and an orthographic projection of the set of peripheral cutting lines on the plane where the flexible display motherboard is located is located inside an orthographic projection of the second sealant on the plane where the flexible display motherboard is located.

The present disclosure also provides a method for cutting an LCD motherboard structure, including:

providing a first rigid substrate and a second rigid substrate, forming a plurality of color filter substrates on the first rigid substrate, and forming a plurality of array substrates on the second rigid substrate;

coating the color filter substrates or the array substrates with a plurality of corresponding first sealants, and bonding the color filter substrates and the corresponding array substrates with the corresponding first sealants, to form a flexible display motherboard, wherein the flexible display motherboard comprises a plurality of display panels; the flexible display motherboard is provided with a set of peripheral cutting lines, a plurality sets of die cutting lines, a plurality of bonding area cutting lines, and a plurality of edge cutting lines; the set of peripheral cutting lines divides the flexible display motherboard into a peripheral area and an internal area for the display panels to be disposed therein; the corresponding set of die cutting lines is for cutting to form each single display panel of the display panels; an orthographic projection of a corresponding portion of each set of die cutting lines on a plane where the display panels are located is located inside an orthographic projection of the corresponding first sealant on the plane where the display panels are located; the corresponding bonding area cutting line is for cutting to form a corresponding bonding area of a corresponding single array substrate of each display panel; and the corresponding edge cutting line is for removing a corresponding portion of the corresponding single color filter substrate of each display panel corresponding to the corresponding bonding area, to expose the corresponding bonding area;

cutting the LCD motherboard structure along the set of peripheral cutting lines, to remove the peripheral area of the flexible display motherboard;

performing laser separation on the flexible display motherboard, to remove the first rigid substrate and the second rigid substrate;

cutting the flexible display motherboard along the corresponding set of die cutting lines, to obtain a corresponding initial display panel for each display panel;

attaching a corresponding polarizer film to each initial display panel;

cutting the corresponding array substrate and the corresponding color filter substrate of each display panel along the corresponding bonding area cutting line at the same time, and cutting the corresponding color filter substrate of each display panel along the corresponding edge cutting line, to form a corresponding further display panel for each display panel; and

bonding a corresponding circuit board to the corresponding bonding area of each further display panel, to form a corresponding flexible LCD panel.

In the method for cutting the LCD motherboard structure of the present disclosure, each display panel comprises a corresponding bonding area; each first sealant comprises a corresponding first sub-sealant, a corresponding second sub-sealant, a corresponding third sub-sealant, and a corresponding fourth sub-sealant; each first sub-sealant is close to the corresponding bonding area; each second sub-sealant is opposite to the corresponding first sub-sealant; each third sub-sealant connects the corresponding first sub-sealant to the corresponding second sub-sealant on a same side of the corresponding first sub-sealant and the corresponding second sub-sealant; and each fourth sub-sealant is opposite to the corresponding third sub-sealant;

wherein each set of die cutting lines comprises a corresponding first sub-cutting line, a corresponding second sub-cutting line, a corresponding third sub-cutting line, and a corresponding fourth sub-cutting line; each first sub-cutting line is close to the corresponding bonding area; and each second sub-cutting line, each third sub-cutting line, and each fourth sub-cutting line are correspondingly disposed corresponding to the corresponding second sub-sealant, the corresponding third sub-sealant, and the corresponding fourth sub-sealant;

wherein an orthographic projection of each first sub-cutting line on the plane where the display panels are located is located outside an orthographic projection of the corresponding first sub-sealant on the plane where the display panels are located;

wherein an orthographic projection of each second sub-cutting line on the plane where the display panels are located is located inside an orthographic projection of the corresponding second sub-sealant on the plane where the display panels are located;

wherein an orthographic projection of a corresponding portion of each third sub-cutting line corresponding to the corresponding third sub-sealant on the plane where the display panels are located is located inside an orthographic projection of the corresponding third sub-sealant on the plane where the display panels are located; and

wherein an orthographic projection of a corresponding portion of each fourth sub-cutting line corresponding to the corresponding fourth sub-sealant on the plane where the display panels are located is located inside an orthographic projection of the corresponding fourth sub-sealant on the plane where the display panels are located.

In the method for cutting the LCD motherboard structure of the present disclosure, each second sub-cutting line divides the corresponding second sub-sealant into a corresponding second outer sub-sealant and a corresponding second inner sub-sealant; each third sub-cutting line divides the corresponding third sub-sealant into a corresponding third outer sub-sealant and a corresponding third inner sub-sealant; and each fourth sub-cutting line divides the corresponding fourth sub-sealant into a corresponding fourth outer sub-sealant and a corresponding fourth inner sub-sealant; and

wherein all of the second outer sub-sealants, the third outer sub-sealants, and the fourth outer sub-sealants have a first predetermined width;

and the second inner sub-sealants, the third inner sub-sealants, and the fourth inner sub-sealants have a plurality of corresponding widths all larger than the first predetermined width.

A width of each first sealant is between 1 cm and 2.5 cm. The first predetermined width is between 0.1 cm and 0.8 cm. Optionally, the width of each first sealant is between 1.8 cm and 2.5 cm. The first predetermined width is between 0.1 cm and 0.5 cm. In this way, enough sealant may be ensured for each flexible LCD panel, so that subsequent bending does not easily cause separation. Further, stress cancellation of each of a plurality of upper flexible substrates and a corresponding lower flexible substrate of a plurality of lower flexible substrates is better controlled because a corresponding set of panel edges of a plurality of sets of panel edges and a corresponding set of sealant edges of a plurality of sets of sealant edges being flat and aligned after cutting using a laser is ensured.

The method for cutting the LCD motherboard structure of the present disclosure further includes: coating the color filter substrates or the array substrates with a plurality of corresponding third sealants, wherein each third sealant is disposed between the corresponding bonding area cutting line and the corresponding first sub-cutting line.

The method for cutting the LCD motherboard structure of the present disclosure further includes: coating the color filter substrates or the array substrates with a second sealant, wherein an orthographic projection of the set of peripheral cutting lines on the plane where the flexible display motherboard is located is located inside an orthographic projection of the second sealant on the plane where the flexible display motherboard is located.

Compared to an existing method for cutting an LCD motherboard structure, the LCD motherboard structure and the cutting method thereof has the following advantage. The corresponding portion of each set of die cutting lines is disposed in the corresponding first sealant. The set of peripheral cutting lines is disposed in the second sealant. Cutting along these two types of cutting lines causes corresponding two types of sealants which are cut and a plurality of corresponding sets of edges from cutting to be flat and aligned. When laser separation is further performed, a plurality corresponding stresses of the flexible substrates bonded to an upper portion and a lower portion of a first type of the two types of sealants cancel each other out. When laser separation is further performed, a plurality corresponding stresses of the flexible substrates bonded to an upper portion and a lower portion of a second type of the two types of sealants cancel each other out. Therefore, energy uneveness caused by curling of peripheral flexible substrates during laser separation is not caused, a situation in which carbonization of a portion where energy is more and inseparability of a portion where energy is less is prevented, and a yield of laser separation is greatly enhanced. Hence, the technical problem that for the existing LCD panel, using laser to separate the rigid substrates from the motherboard may easily cause the corresponding flexible substrates of the motherboard to curl is solved.

### DESCRIPTION OF DRAWINGS

In order to describe a technical solution in embodiments or existing technology more clearly, drawings required to be used by the embodiments are briefly introduced below. The drawings in the description below are only some embodiments of the present disclosure. With respect to persons of ordinary skill in the art, under a premise that inventive efforts are not made, other drawings may be obtained based on these drawings.

FIG. 1 is a schematic structural diagram of an existing liquid crystal display (LCD) motherboard structure.

FIG. 2 is a schematic structural diagram of an LCD motherboard structure in accordance with some embodiments of the present disclosure.

FIG. 3 is a schematic structural diagram of a portion of the LCD motherboard structure in accordance with some embodiments of the present disclosure.

FIG. 4 is another schematic structural diagram of the LCD motherboard structure in accordance with some embodiments of the present disclosure.

FIG. 5 is a flowchart of a method for cutting an LCD motherboard structure in accordance with some embodiments of the present disclosure.

### DETAILED DESCRIPTION OF PREFERRED EMBODIMENTS

Refer to diagrams in the drawings. A same element is labeled by a same reference numeral. Description below is based on exemplified specific embodiments of the present disclosure, which should not be construed as limiting other specific embodiments of the present disclosure not described herein.

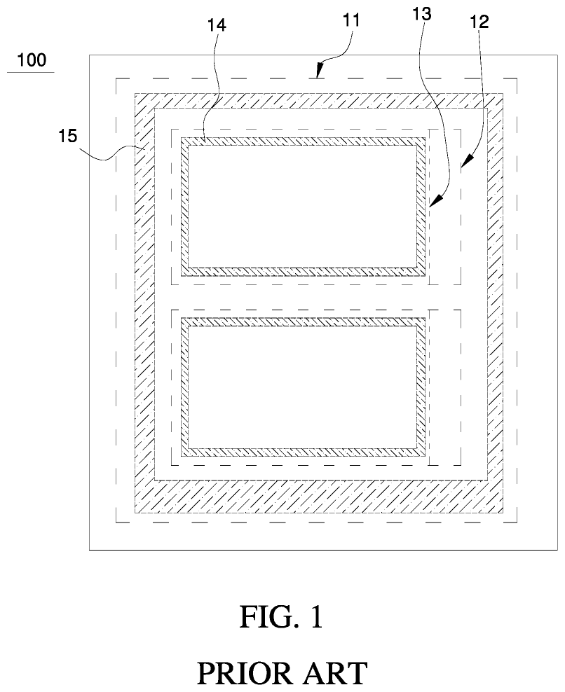

Referring to FIG. 1, first, an existing liquid crystal display (LCD) motherboard structure is briefly introduced herein. The existing LCD motherboard structure 100 is provided with a set of peripheral cutting lines 11, a plurality of sets of die cutting lines 12, and a plurality of edge cutting lines 13. Each set of die cutting lines 12 is for cutting a corresponding entire display panel and a corresponding bonding area of the corresponding display panel. Each edge cutting line 13 is for cutting off a corresponding portion of a corresponding color filter substrate corresponding to the corresponding bonding area of a corresponding array substrate, to expose the corresponding bonding area. In addition, the LCD motherboard 100 further includes a plurality of first sealants 14 and a second sealant 15. The first sealants 14 are for bonding a plurality of corresponding color filter substrates and a plurality of corresponding array substrates, to form a plurality of corresponding display panels.

In the related art, because a cutting precision problem is considered, a plurality of sealants are disposed at least 200 um inside a plurality of corresponding sets of cutting lines, such as a distance between each first sealant 14 and the corresponding set of die cutting lines 12, and a distance between the second sealant 15 and the set of peripheral cutting lines 11. In this way, during cutting, a precision problem that causes a cutting wheel to cut a sealant and therefore unable to break is prevented.

However, when this type of design is applied to a plurality of flexible LCD panels, because a corresponding set of edges has a distance of at least 200 um from each sealant, during laser separation, a stress problem causes corresponding outer edge portions of each sealant to curl, wherein the corresponding outer edge portions curl toward corresponding rigid substrates. Therefore, a focus of a laser is changed, causing separation to be uneven, causing carbonization of a portion where laser energy is more and inseparability of a portion where laser energy is less. At the same time, the curls caused by this type of situation increase difficulty of polarizer film attachment and difficulty of bonding.

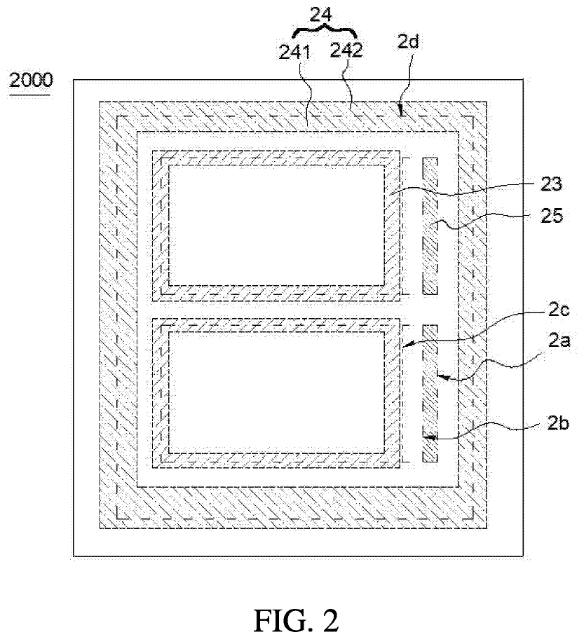

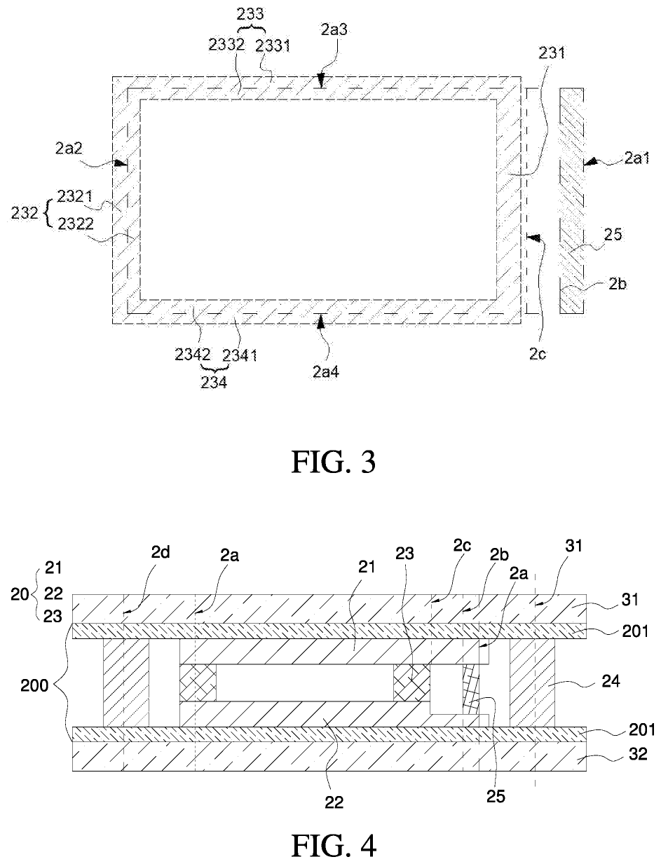

Referring to FIGS. 2 to 4, FIG. 2 is a schematic structural diagram of an LCD motherboard structure in accordance with some embodiments of the present disclosure. FIG. 3 is a schematic structural diagram of a portion of the LCD motherboard structure in accordance with some embodiments of the present disclosure. FIG. 4 is another schematic structural diagram of the LCD motherboard structure in accordance with some embodiments of the present disclosure.

An LCD motherboard structure 2000 in accordance with some embodiments of the present disclosure includes a flexible display motherboard 200, and a first rigid substrate 31 and a second rigid substrate 32 disposed on two sides of the flexible display motherboard 200. The flexible display motherboard 200 comprises a plurality of display panels 20. The display panels 20 include a plurality of corresponding color filter substrates 21 formed on the first rigid substrate 31, a plurality of corresponding array substrates 22 formed on the second rigid substrate 32, and a plurality of corresponding first sealants 23 between the corresponding color filter substrates 21 and the corresponding array substrates 22. Both each color filter substrate 21 and the corresponding array substrate 22 includes corresponding flexible substrates 201. A plurality of flexible substrates 201 are respectively formed on the first rigid substrate 31 and the second rigid substrate 32.

Each color filter substrate 21 is sealed and bonded by the corresponding first sealant 23. In the present embodiment, each first sealant 23 has a rectangular shape, but is not limited thereto. The flexible display motherboard 200 is provided with a plurality of sets of die cutting lines 2a. Each set of die cutting lines 2a is for cutting to form a corresponding single initial display panel. In the present embodiment, each set of die cutting lines 2a has a rectangular shape, but is not limited thereto.

An orthographic projection of a corresponding portion of each set of die cutting lines 2a on a plane where the display panels 20 are located is located inside an orthographic projection of the corresponding first sealant 23 on the plane where the display panels 20 are located.

It is to be noted that a plurality of corresponding stresses of the two flexible substrates 201 are respectively toward the first rigid substrate 31 and the second rigid substrate 32. After a corresponding liquid crystal cell is formed from each color filter substrate 21 and the corresponding array substrate 22, the corresponding stresses correspondingly of each two have opposite directions. The corresponding first sealant 23 bonds each two. Therefore, the corresponding stresses of the two flexible substrates 201 cancel each other out.

Along each set of die cutting lines 2a, cutting is performed using a laser. After cutting, a corresponding set of edges of each first sealant 23 and a corresponding set of edges of the corresponding initial display panel are flat and aligned. Then, when each initial display panel is separated from the corresponding first rigid substrate 31 and the corresponding second rigid substrate 32 using the laser, the corresponding stresses correspondingly of the corresponding flexible substrates 201 bonded to a corresponding upper portion and a corresponding lower portion of the corresponding first sealant 23 cancel each other out. Therefore, energy uneveness caused by curling of corresponding peripheral flexible substrates for each initial display panel during laser separation is not caused, a situation in which carbonization of a portion where energy is more and inseparability of a portion where energy is less is prevented, and a yield of laser separation is greatly enhanced. The corresponding stresses correspondingly of the corresponding flexible substrates 201 bonded to a corresponding upper portion and a corresponding lower portion of each first sealant 23 cancel each other out. Therefore, flatness of each array substrate 22 and the corresponding color filter substrate 21 is maintained after the corresponding first rigid substrate 31 and the corresponding second rigid substrate 32 are removed. Hence, difficulty of polarizer film attachment is prevented from happening.

Specifically, each display panel 20 includes a corresponding bonding area, which is the corresponding bonding area of the corresponding array substrate 22. Each first sealant 23 includes a corresponding first sub-sealant 231, a corresponding second sub-sealant 232, a corresponding third sub-sealant 233, and a corresponding fourth sub-sealant 234. Each first sub-sealant 231 is close to the corresponding bonding area. Each second sub-sealant 232 is opposite to the corresponding first sub-sealant 231. Each third sub-sealant 233 connects the corresponding first sub-sealant 231 to the corresponding second sub-sealant 232 on a same side of the corresponding first sub-sealant 231 and the corresponding second sub-sealant 232. Each fourth sub-sealant 234 is opposite to the corresponding third sub-sealant 233.

Each set of die cutting lines 2a includes a corresponding first sub-cutting line 2a1, a corresponding second sub-cutting line 2a2, a corresponding third sub-cutting line 2a3, and a corresponding fourth sub-cutting line 2a4. Each first sub-cutting line 2a1 is close to the corresponding bonding area. Each second sub-cutting line 2a2, each third sub-cutting line 2a3, and each fourth sub-cutting line 2a4 are correspondingly disposed corresponding to the corresponding second sub-sealant 232, the corresponding third sub-sealant 233, and the corresponding fourth sub-sealant 234.

An orthographic projection of each first sub-cutting line 2a1 on the plane where the display panels 20 are located is located outside an orthographic projection of the corresponding first sub-sealant 231 on the plane where the display panels 20 are located.

An orthographic projection of each second sub-cutting line 2a2 on the plane where the display panels 20 are located is located inside an orthographic projection of the corresponding second sub-sealant 232 on the plane where the display panels 20 are located.

An orthographic projection of a corresponding portion of each third sub-cutting line 2a3 corresponding to the corresponding third sub-sealant 233 on the plane where the display panels 20 are located is located inside an orthographic projection of the corresponding third sub-sealant 233 on the plane where the display panels 20 are located.

An orthographic projection of a corresponding portion of each fourth sub-cutting line 2a4 corresponding to the corresponding fourth sub-sealant 234 on the plane where the display panels 20 are located is located inside an orthographic projection of the corresponding fourth sub-sealant 234 on the plane where the display panels 20 are located.

In addition, the flexible display motherboard 200 is provided with a corresponding bonding area cutting line 2b for cutting to form the corresponding bonding area of the corresponding array substrate 22 of each display panel 20. A corresponding third sealant 25 is disposed between each bonding area cutting line 2b and the corresponding first sub-cutting line 2a1. The bonding area of the corresponding array substrate 22 is disposed on a side of each bonding area cutting line 2b close to the corresponding first sealant 23. The corresponding third sealant 25 is disposed on another side of each bonding area cutting line 2b. When cutting along the corresponding set of die cutting lines 2a is finished, a periphery of the corresponding bonding area of the corresponding array substrate 22 and a periphery of the corresponding color filter substrate 21 are bonded together by each third sealant 25. Therefore, when laser peeling is performed on the corresponding rigid substrates, the corresponding flexible substrate of each bonding area does not curl, thereby avoiding occurrence of inability to bond a corresponding circuit board to each bonding area.

In the present embodiment, each second sub-cutting line 2a2 divides the corresponding second sub-sealant 232 into a corresponding second outer sub-sealant 2321 and a corresponding second inner sub-sealant 2322. Each third sub-cutting line 2a3 divides the corresponding third sub-sealant 233 into a corresponding third outer sub-sealant 2331 and a corresponding third inner sub-sealant 2332. Each fourth sub-cutting line 2a4 divides the corresponding fourth sub-sealant 234 into a corresponding fourth outer sub-sealant 2341 and a corresponding fourth inner sub-sealant 2342.

All of the second outer sub-sealants 2321, the third outer sub-sealants 2331, and the fourth outer sub-sealants 2341 have a first predetermined width. The second inner sub-sealants 2322, the third inner sub-sealants 2332, and the fourth inner sub-sealants 2342 have a plurality of corresponding widths all larger than the first predetermined width.

A width of each first sealant 23 is between 1 cm and 2.5 cm. The first predetermined width is between 0.1 cm and 0.8 cm. Optionally, the width of each first sealant 23 is between 1.8 cm and 2.5 cm. The first predetermined width is between 0.1 cm and 0.5 cm. In this way, enough sealant may be ensured for each flexible LCD panel, so that subsequent bending does not easily cause separation. Further, stress cancellation of the corresponding flexible substrates 201 for each flexible LCD panel is better controlled because the corresponding set of panel edges and the corresponding set of sealant edges being flat and aligned after cutting using a laser is ensured.

In the present embodiment, each display panel 20 is further provided, on a side of the corresponding color filter substrate 21 of each display panel, with a corresponding edge cutting line 2c. The corresponding edge cutting line 2c is for removing a corresponding portion of the corresponding single color filter substrate 21 of each display panel 20 corresponding to the corresponding bonding area, to expose the corresponding bonding area.

The flexible display motherboard 200 is provided with a set of peripheral cutting lines 2d. The set of peripheral cutting lines 2d divides the flexible display motherboard 200 into a peripheral area and an internal area for the display panels 20 to be disposed therein. The peripheral area is disposed surrounding the internal area. The set of peripheral cutting lines 2d has a rectangular shape, but is not limited thereto.

The flexible display motherboard 200 includes a second sealant 24. In the present embodiment, the second sealant 24 has a rectangular shape, but is not limited thereto. An orthographic projection of the set of peripheral cutting lines 2d on the plane where the flexible display motherboard 200 is located is located inside an orthographic projection of the second sealant 24 on the plane where the flexible display motherboard 200 is located.

Along the set of peripheral cutting lines 2d, cutting is performed using a laser. After cutting, a set of edges of the second sealant 24 and a set of edges of the initial flexible display motherboard are flat and aligned. Then, when the initial flexible display motherboard is separated from the first rigid substrate 31 and the second rigid substrate 32 using the laser, the stresses correspondingly of the flexible substrates 201 bonded to an upper portion and a lower portion of the second sealant 24 cancel each other out. Therefore, energy uneveness caused by curling of peripheral flexible substrates during laser separation is not caused, a situation in which carbonization of a portion where energy is more and inseparability of a portion where energy is less is prevented, and a yield of laser separation is greatly enhanced. The stresses correspondingly of the flexible substrates 201 bonded to an upper portion and a lower portion of the second sealant 24 cancel each other out. Therefore, flatness of the array substrates 22 and the color filter substrates 21 is maintained after the first rigid substrate 31 and the second rigid substrate 32 are removed. Hence, difficulty of polarizer film attachment is prevented from happening.

Specifically, the set of peripheral cutting lines 2d divides the second sealant 24 into an inner sealant 241 and an outer sealant 242. A width of one strip of the inner sealant 241 is larger than a width of one strip of the outer sealant 242. Optionally, the width of one strip of the outer sealant 242 may be equal to the first predetermined width, but is not limited thereto.

There are two cutting methods for manufacturing the flexible display panels for the LCD motherboard structure 2000 in accordance with some embodiments of the present disclosure. The first method involves first cutting along the set of peripheral cutting lines 2d, then performing separation for the first rigid substrate 31 and the second rigid substrate 32, and then cutting along the sets of die cutting lines 2a. The second method involves first cutting along the set of peripheral cutting lines 2d, then cutting along the sets of die cutting lines 2a, and then performing separation for the corresponding first rigid substrates 31 and the corresponding second rigid substrates 32. Therefore, only each first sealant 23 may be provided for the second cutting method of the present disclosure, to solve a technical problem that the corresponding flexible substrates curl during laser separation for the corresponding rigid substrates. Also, only the second sealant 24 may be provided for the first cutting method, to solve a technical problem that the flexible substrates curl during laser separation for the rigid substrates. Of course, not only each first sealant 23 is provided, but also the second sealant 24 is provided in some embodiments of the present disclosure, to correspond to the two cutting methods.

Please refer to specific content of a method for cutting an LCD motherboard structure described for corresponding specific steps of each cutting method for the LCD motherboard 2000 in the present embodiment, which are not described here. It is to be noted that the LCD motherboard 2000 in the present embodiment has a same structure as the LCD motherboard structure describe below.

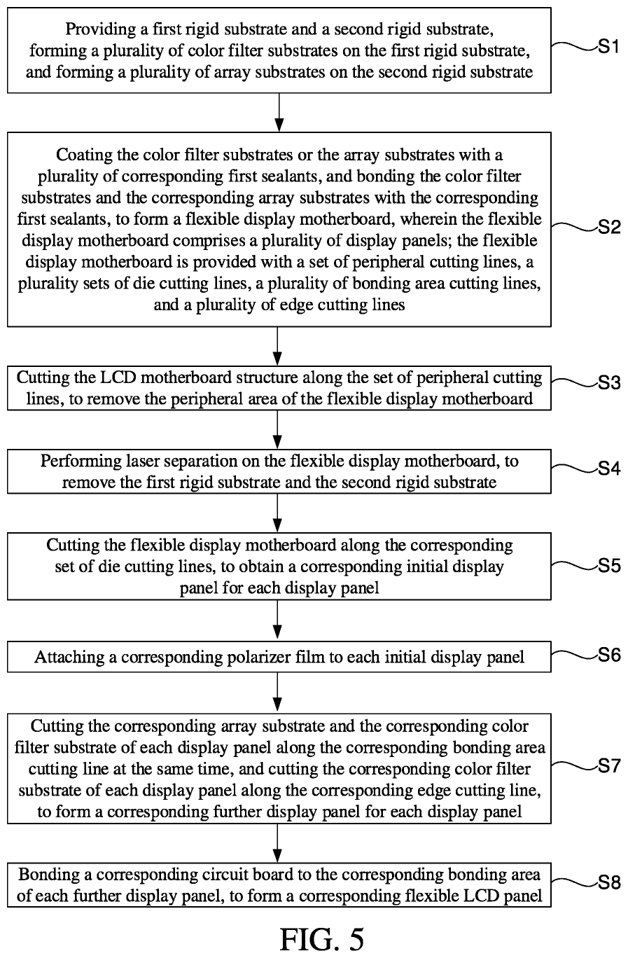

Referring to FIGS. 2 to 5, FIG. 5 is a flowchart of the method for cutting the LCD motherboard structure in accordance with some embodiments of the present disclosure. The present disclosure also provides a method for cutting an LCD motherboard structure, including:

a step S1 of providing a first rigid substrate and a second rigid substrate, forming a plurality of color filter substrates on the first rigid substrate, and forming a plurality of array substrates on the second rigid substrate;

a step S2 of coating the color filter substrates or the array substrates with a plurality of corresponding first sealants, and bonding the color filter substrates and the corresponding array substrates with the corresponding first sealants, to form a flexible display motherboard, wherein the flexible display motherboard comprises a plurality of display panels; the flexible display motherboard is provided with a set of peripheral cutting lines, a plurality sets of die cutting lines, a plurality of bonding area cutting lines, and a plurality of edge cutting lines; the set of peripheral cutting lines divides the flexible display motherboard into a peripheral area and an internal area for the display panels to be disposed therein; the corresponding set of die cutting lines is for cutting to form each single display panel of the display panels; an orthographic projection of a corresponding portion of each set of die cutting lines on a plane where the display panels are located is located inside an orthographic projection of the corresponding first sealant on the plane where the display panels are located; the corresponding bonding area cutting line is for cutting to form a corresponding bonding area of a corresponding single array substrate of each display panel; and the corresponding edge cutting line is for removing a corresponding portion of the corresponding single color filter substrate of each display panel corresponding to the corresponding bonding area, to expose the corresponding bonding area;

a step S3 of cutting the LCD motherboard structure along the set of peripheral cutting lines, to remove the peripheral area of the flexible display motherboard;

a step S4 of performing laser separation on the flexible display motherboard, to remove the first rigid substrate and the second rigid substrate;

a step S5 of cutting the flexible display motherboard along the corresponding set of die cutting lines, to obtain a corresponding initial display panel for each display panel;

a step S6 of attaching a corresponding polarizer film to each initial display panel;

a step S7 of cutting the corresponding array substrate and the corresponding color filter substrate of each display panel along the corresponding bonding area cutting line at the same time, and cutting the corresponding color filter substrate of each display panel along the corresponding edge cutting line, to form a corresponding further display panel for each display panel; and

a step S8 of bonding a corresponding circuit board to the corresponding bonding area of each further display panel, to form a corresponding flexible LCD panel.

A detailed description of the method for cutting the LCD motherboard structure 2000 is as follows.

In the step S1, a first rigid substrate 31 and a second rigid substrate 32 are provided, a plurality of color filter substrates 21 are formed on the first rigid substrate 31, and a plurality of array substrates 22 are formed on the second rigid substrate 32.

Specifically, the step S1 includes:

forming a plurality of flexible substrates 201 respectively on the first rigid substrate 31 and the second rigid substrate 31;

manufacturing a plurality of color films on one of the flexible substrates 201, to form the color filter substrates 21; and

manufacturing a plurality of arrays on another of the flexible substrates 201, to form the array substrates 22.

Then, the method proceeds to the step S2.

In the step S2, the color filter substrates 21 or the array substrates 22 are coated with a plurality of corresponding first sealants 23, and the color filter substrates 21 and the corresponding array substrates 22 are bonded with the corresponding first sealants 23, to form a flexible display motherboard 200.

Specifically, the flexible display motherboard 200 comprises a plurality of display panels 20; the flexible display motherboard 200 is provided with a set of peripheral cutting lines 2d, a plurality sets of die cutting lines 2a, a plurality of bonding area cutting lines 2b, and a plurality of edge cutting lines 2c.

The set of peripheral cutting lines 2d divides the flexible display motherboard 200 into a peripheral area and an internal area for the display panels 20 to be disposed therein. The set of peripheral cutting lines 2d is for cutting off the peripheral area of the flexible display motherboard 200. The color filter substrates 21 or the array substrates 22 are coated with a second sealant 24. An orthographic projection of the set of peripheral cutting lines 2d on the plane where the flexible display motherboard 200 is located is located inside an orthographic projection of the second sealant 24 on the plane where the flexible display motherboard 200 is located. In the present embodiment, each of the set of peripheral cutting lines 2d and the second sealant 24 having a corresponding rectangular shape is used as an example for illustration, but is not limited thereto.

Specifically, the set of peripheral cutting lines 2d divides the second sealant 24 into an inner sealant 241 and an outer sealant 242. A width of one strip of the inner sealant 241 is larger than a width of one strip of the outer sealant 242. Optionally, the width of one strip of the outer sealant 242 may be equal to the first predetermined width (as described below), but is not limited thereto.

Each set of die cutting lines 2a is for cutting to form a corresponding single initial display panel. An orthographic projection of a corresponding portion of each set of die cutting lines 2a on a plane where the display panels 20 are located is located inside an orthographic projection of the corresponding first sealant 23 on the plane where the display panels 20 are located. In the present embodiment, each of the sets of die cutting lines 2a and the first sealants 23 having a corresponding rectangular shape is used as an example for illustration, but is not limited thereto.

Specifically, each display panel 20 includes a corresponding bonding area, which is the corresponding bonding area of the corresponding array substrate 22. Each first sealant 23 includes a corresponding first sub-sealant 231, a corresponding second sub-sealant 232, a corresponding third sub-sealant 233, and a corresponding fourth sub-sealant 234. Each first sub-sealant 231 is close to the corresponding bonding area. Each second sub-sealant 232 is opposite to the corresponding first sub-sealant 231. Each third sub-sealant 233 connects the corresponding first sub-sealant 231 to the corresponding second sub-sealant 232 on a same side of the corresponding first sub-sealant 231 and the corresponding second sub-sealant 232. Each fourth sub-sealant 234 is opposite to the corresponding third sub-sealant 233.

Each set of die cutting lines 2a includes a corresponding first sub-cutting line 2a1, a corresponding second sub-cutting line 2a2, a corresponding third sub-cutting line 2a3, and a corresponding fourth sub-cutting line 2a4. Each first sub-cutting line 2a1 is close to the corresponding bonding area. Each second sub-cutting line 2a2, each third sub-cutting line 2a3, and each fourth sub-cutting line 2a4 are correspondingly disposed corresponding to the corresponding second sub-sealant 232, the corresponding third sub-sealant 233, and the corresponding fourth sub-sealant 234.

An orthographic projection of each first sub-cutting line 2a1 on the plane where the display panels 20 are located is located outside an orthographic projection of the corresponding first sub-sealant 231 on the plane where the display panels 20 are located.

An orthographic projection of each second sub-cutting line 2a2 on the plane where the display panels 20 are located is located inside an orthographic projection of the corresponding second sub-sealant 232 on the plane where the display panels 20 are located.

An orthographic projection of a corresponding portion of each third sub-cutting line 2a3 corresponding to the corresponding third sub-sealant 233 on the plane where the display panels 20 are located is located inside an orthographic projection of the corresponding third sub-sealant 233 on the plane where the display panels 20 are located.

An orthographic projection of a corresponding portion of each fourth sub-cutting line 2a4 corresponding to the corresponding fourth sub-sealant 234 on the plane where the display panels 20 are located is located inside an orthographic projection of the corresponding fourth sub-sealant 234 on the plane where the display panels 20 are located.

The corresponding bonding area cutting line 2b is for cutting to form a corresponding bonding area of a corresponding single array substrate 22 of each display panel 20. The corresponding edge cutting line 2b is for removing a corresponding portion of the corresponding single color filter substrate 21 of each display panel 20 corresponding to the corresponding bonding area, to expose the corresponding bonding area.

Each second sub-cutting line 2a2 divides the corresponding second sub-sealant 232 into a corresponding second outer sub-sealant 2321 and a corresponding second inner sub-sealant 2322. Each third sub-cutting line 2a3 divides the corresponding third sub-sealant 233 into a corresponding third outer sub-sealant 2331 and a corresponding third inner sub-sealant 2332. Each fourth sub-cutting line 2a4 divides the corresponding fourth sub-sealant 234 into a corresponding fourth outer sub-sealant 2341 and a corresponding fourth inner sub-sealant 2342.

All of the second outer sub-sealants 2321, the third outer sub-sealants 2331, and the fourth outer sub-sealants 2341 have a first predetermined width. The second inner sub-sealants 2322, the third inner sub-sealants 2332, and the fourth inner sub-sealants 2342 have a plurality of corresponding widths all larger than the first predetermined width.

A width of each first sealant 23 is between 1 cm and 2.5 cm. The first predetermined width is between 0.1 cm and 0.8 cm. Optionally, the width of each first sealant 23 is between 1.8 cm and 2.5 cm. The first predetermined width is between 0.1 cm and 0.5 cm. In this way, enough sealant may be ensured for each flexible LCD panel, so that subsequent bending does not easily cause separation. Further, stress cancellation of the corresponding flexible substrates 201 for each flexible LCD panel is better controlled because the corresponding set of panel edges and the corresponding set of sealant edges being flat and aligned after cutting using a laser is ensured.

The color filter substrates 21 or the array substrates 22 are coated with a plurality of corresponding third sealants 25. Each third sealant 25 is disposed between the corresponding bonding area cutting line 2b and the corresponding first sub-cutting line 2a1.

The corresponding edge cutting line 2c is for removing a corresponding portion of the corresponding single color filter substrate 21 of each display panel 20 corresponding to the corresponding bonding area, to expose the corresponding bonding area of the corresponding array substrate 22.

Then, the proceeds to the step S3. The LCD motherboard structure 2000 is cut along the set of peripheral cutting lines 2d, to remove the peripheral area of the flexible display motherboard 200. Therefore, an initial flexible display motherboard 200 is obtained.

Specifically, cutting is performed first using a laser, so that the flexible substrates 201 and corresponding film layers thereon are cut to be disconnected. Then, the rigid substrates are cut to be broken using mechanical cutter wheel cutting. Optionally, a laser with larger energy may be used so that the rigid substrates, the corresponding flexible substrates, and the corresponding film layers on the corresponding flexible substrates are cut to be disconnected at a time. Laser cutting includes, but is not limited to, ultraviolet cutting, infrared cutting, CO2 cutting, and the like.

The set of peripheral cutting lines 2d divides the second sealant 24 into an inner sealant 241 and an outer sealant 242. Therefore, after cutting, a set of edges of the inner sealant 241 and a set of edges of the flexible display motherboard 200 are flat and aligned.

Therefore, after cutting, the flexible display panel 200 still has the inner sealant 241. The flexible substrate 201 on the color filter substrates 21 and the flexible substrate 201 on the array substrates 22 are bonded together by the inner sealant 241.

Then, the method proceeds to the step S4.

In the step S4, laser separation is performed on the flexible display motherboard 200, to remove the first rigid substrate 31 and the second rigid substrate 32.

Specifically, the stresses correspondingly of the flexible substrates 201 bonded to an upper portion and a lower portion of the inner sealant 241 cancel each other out. Therefore, energy uneveness caused by curling of peripheral flexible substrates 201 during laser separation is not caused, a situation in which carbonization of a portion where energy is more and inseparability of a portion where energy is less is prevented, and a yield of laser separation is greatly enhanced. The stresses correspondingly of the flexible substrates 201 bonded to an upper portion and a lower portion of the inner sealant 241 cancel each other out. Therefore, flatness of the array substrates 22 and the color filter substrates 21 is maintained after the first rigid substrate 31 and the second rigid substrate 32 are removed. Hence, difficulty of polarizer film attachment is prevented from happening.

Then, the method proceeds to the step S5.

In the step S5, the flexible display motherboard 200 is cut along the corresponding sets of die cutting lines 2a, to obtain a corresponding initial display panel for each display panel 20.

The bonding area of the corresponding array substrate 22 is disposed on a side of each bonding area cutting line 2b close to the corresponding first sealant 23. The corresponding third sealant 25 is disposed on another side of each bonding area cutting line 2b. When cutting along the corresponding set of die cutting lines 2a is finished, a periphery of the corresponding bonding area of the corresponding array substrate 22 and a periphery of the corresponding color filter substrate 21 are bonded together by each third sealant 25. Therefore, when laser peeling is performed on the corresponding rigid substrates, the corresponding flexible substrate of each bonding area does not curl, thereby avoiding occurrence of inability to bond a corresponding circuit board to each bonding area.

Then, the method proceeds to the step S6.

In the step S6, a corresponding polarizer film is attached to each initial display. Specifically, a plurality of corresponding polarizer films are respectively attached to the corresponding color filter substrate 21 and the corresponding array substrate 22 of each initial display. Then, the method proceeds to the step S7.

In the step S7, the corresponding array substrate and the corresponding color filter substrate of each display panel are cut along the corresponding bonding area cutting line at the same time, and the corresponding color filter substrate of each display panel is cut along the corresponding edge cutting line, to form a corresponding further display panel for each display panel.

Specifically, cutting is performed along the corresponding bonding area cutting line 2b, to remove the corresponding third sealant 25 behind each bonding area. Cutting is performed along the corresponding edge cutting line 2c, to remove a corresponding portion of the corresponding color filter substrate 21 corresponding to each bonding area, to expose each bonding area. In addition, because the corresponding polarizer films are attached, and the corresponding flexible substrates 201 are bonded between the corresponding upper and lower polarizer films, natural curling does not occur, facilitating a bonding process for each bonding area in the step S8. Then, the method proceeds to the step S8.

In the step S8, a corresponding circuit board is bonded to the corresponding bonding area of each further display panel, to form a corresponding flexible LCD panel.

In this way, the method for cutting the LCD motherboard structure in accordance with some embodiments of the present disclosure is finished.

In addition, in some embodiments, the steps S5 and S4 are performed in sequence after the step S3 is performed, and then the steps S6, S7, and S8 are performed. That is, the step S4 and the step S5 in the above embodiment are reversed.

Specifically, the step S5 is first performed. In the step S5, the flexible display motherboard 200 is cut along the corresponding sets of die cutting lines 2a, to obtain a corresponding initial display panel for each display panel 20. The initial display panel for each display panel 20 has the corresponding rigid substrates (the corresponding first rigid substrate 31 and the corresponding second rigid substrate 32) thereon.

Then, the step S4 is performed. In the step S4, laser separation is performed on the flexible display motherboard 200, to remove the first rigid substrate 31 and the second rigid substrate 32. The “flexible display motherboard 200” in “laser separation is performed on the flexible display motherboard 200” is the remaining corresponding initial display panel for each display panel 20 of the flexible display motherboard 200 after the step S5.

Along each set of die cutting lines 2a, cutting is performed using a laser. After cutting, a corresponding set of edges of each first sealant 23 and a corresponding set of edges of the corresponding initial display panel are flat and aligned. Then, when each initial display panel is separated from the corresponding first rigid substrate 31 and the corresponding second rigid substrate 32 using the laser, the corresponding stresses correspondingly of the corresponding flexible substrates 201 bonded to a corresponding upper portion and a corresponding lower portion of the corresponding first sealant 23 cancel each other out. Therefore, energy uneveness caused by curling of corresponding peripheral flexible substrates for each initial display panel during laser separation is not caused, a situation in which carbonization of a portion where energy is more and inseparability of a portion where energy is less is prevented, and a yield of laser separation is greatly enhanced. The corresponding stresses correspondingly of the corresponding flexible substrates 201 bonded to a corresponding upper portion and a corresponding lower portion of each first sealant 23 cancel each other out. Therefore, flatness of each array substrate 22 and the corresponding color filter substrate 21 is maintained after the corresponding first rigid substrate 31 and the corresponding second rigid substrate 32 are removed. Hence, difficulty of polarizer film attachment is prevented from happening.

Compared to an existing method for cutting an LCD motherboard structure, the LCD motherboard structure and the cutting method thereof has the following advantage. The corresponding portion of each set of die cutting lines is disposed in the corresponding first sealant. The set of peripheral cutting lines is disposed in the second sealant. Cutting along these two types of cutting lines causes corresponding two types of sealants which are cut and a plurality of corresponding sets of edges from cutting to be flat and aligned. When laser separation is further performed, a plurality corresponding stresses of the flexible substrates bonded to an upper portion and a lower portion of a first type of the two types of sealants cancel each other out. When laser separation is further performed, a plurality corresponding stresses of the flexible substrates bonded to an upper portion and a lower portion of a second type of the two types of sealants cancel each other out. Therefore, energy uneveness caused by curling of peripheral flexible substrates during laser separation is not caused, a situation in which carbonization of a portion where energy is more and inseparability of a portion where energy is less is prevented, and a yield of laser separation is greatly enhanced. Hence, the technical problem that for the existing LCD panel, using laser to separate the rigid substrates from the motherboard may easily cause the corresponding flexible substrates of the motherboard to curl is solved.

To persons skilled in the art, in accordance with the technical solutions and technical ideas of the present disclosure, various changes and modifications may be made to the description above. All these changes and modifications are within the protection scope of the claims of the present disclosure.

What is claimed is:

1. A liquid crystal display (LCD) motherboard structure, comprising: a flexible display motherboard, and a first rigid substrate and a second rigid substrate disposed on two sides of the flexible display motherboard, wherein the flexible display motherboard comprises a plurality of display panels;
wherein the display panels comprise a plurality of corresponding first sealants for bonding a plurality of corresponding color filter substrates and a plurality of corresponding array substrates; and the flexible display motherboard is provided with a corresponding set of die cutting lines for cutting to form each single display panel of the display panels;
wherein an orthographic projection of a corresponding portion of each set of die cutting lines on a plane where the display panels are located is located inside an orthographic projection of the corresponding first sealant on the plane where the display panels are located;
wherein each display panel comprises a corresponding bonding area; each first sealant comprises a corresponding first sub-sealant, a corresponding second sub-sealant, a corresponding third sub-sealant, and a corresponding fourth sub-sealant; each first sub-sealant is close to the corresponding bonding area; each second sub-sealant is opposite to the corresponding first sub-sealant; each third sub-sealant connects the corresponding first sub-sealant to the corresponding second sub-sealant on a same side of the corresponding first sub-sealant and the corresponding second sub-sealant; and each fourth sub-sealant is opposite to the corresponding third sub-sealant;
wherein each set of die cutting lines comprises a corresponding first sub-cutting line, a corresponding second sub-cutting line, a corresponding third sub-cutting line, and a corresponding fourth sub-cutting line; each first sub-cutting line is close to the corresponding bonding area; and each second sub-cutting line, each third sub-cutting line, and each fourth sub-cutting line are correspondingly disposed corresponding to the corresponding second sub-sealant, the corresponding third sub-sealant, and the corresponding fourth sub-sealant;
wherein an orthographic projection of each first sub-cutting line on the plane where the display panels are located is located outside an orthographic projection of the corresponding first sub-sealant on the plane where the display panels are located;
wherein an orthographic projection of each second sub-cutting line on the plane where the display panels are located is located inside an orthographic projection of the corresponding second sub-sealant on the plane where the display panels are located;
wherein an orthographic projection of a corresponding portion of each third sub-cutting line corresponding to the corresponding third sub-sealant on the plane where the display panels are located is located inside an orthographic projection of the corresponding third sub-sealant on the plane where the display panels are located;
wherein an orthographic projection of a corresponding portion of each fourth sub-cutting line corresponding to the corresponding fourth sub-sealant on the plane where the display panels are located is located inside an orthographic projection of the corresponding fourth sub-sealant on the plane where the display panels are located;
wherein the flexible display motherboard is provided with a set of peripheral cutting lines; the set of peripheral cutting lines divides the flexible display motherboard into a peripheral area and an internal area for the display panels to be disposed therein; and the peripheral area is disposed surrounding the internal area; and
wherein the flexible display motherboard further comprises a second sealant; and an orthographic projection of the set of peripheral cutting lines on the plane where the flexible display motherboard is located is located inside an orthographic projection of the second sealant on the plane where the flexible display motherboard is located.

2. The LCD motherboard structure of claim 1, wherein each second sub-cutting line divides the corresponding second sub-sealant into a corresponding second outer sub-sealant and a corresponding second inner sub-sealant; each third sub-cutting line divides the corresponding third sub-sealant into a corresponding third outer sub-sealant and a corresponding third inner sub-sealant; and each fourth sub-cutting line divides the corresponding fourth sub-sealant into a corresponding fourth outer sub-sealant and a corresponding fourth inner sub-sealant; and
wherein all of the second outer sub-sealants, the third outer sub-sealants, and the fourth outer sub-sealants have a first predetermined width; and the second inner sub-sealants, the third inner sub-sealants, and the fourth inner sub-sealants have a plurality of corresponding widths all larger than the first predetermined width.

3. The LCD motherboard structure of claim 1, wherein the flexible display motherboard is provided with a corresponding bonding area cutting line for cutting to form the corresponding bonding area of the corresponding array substrate of each display panel; and each third sealant is disposed between the corresponding bonding area cutting line and the corresponding first sub-cutting line.

4. The LCD motherboard structure of claim 3, wherein each display panel is further provided, on a side of the corresponding color filter substrate of each display panel, with a corresponding edge cutting line; and the corresponding edge cutting line is for removing a corresponding portion of the corresponding single color filter substrate of each display panel corresponding to the corresponding bonding area, to expose the corresponding bonding area.

5. A liquid crystal display (LCD) motherboard structure, comprising: a flexible display motherboard, and a first rigid substrate and a second rigid substrate disposed on two sides of the flexible display motherboard, wherein the flexible display motherboard comprises a plurality of display panels;
wherein the display panels comprise a plurality of corresponding first sealants for bonding a plurality of corresponding color filter substrates and a plurality of corresponding array substrates; and the flexible display motherboard is provided with a corresponding set of die cutting lines for cutting to form each single display panel of the display panels; and
wherein an orthographic projection of a corresponding portion of each set of die cutting lines on a plane where the display panels are located is located inside an orthographic projection of the corresponding first sealant on the plane where the display panels are located.

6. The LCD motherboard structure of claim 5, wherein each display panel comprises a corresponding bonding area; each first sealant comprises a corresponding first sub-sealant, a corresponding second sub-sealant, a corresponding third sub-sealant, and a corresponding fourth sub-sealant; each first sub-sealant is close to the corresponding bonding area; each second sub-sealant is opposite to the corresponding first sub-sealant; each third sub-sealant connects the corresponding first sub-sealant to the corresponding second sub-sealant on a same side of the corresponding first sub-sealant and the corresponding second sub-sealant; and each fourth sub-sealant is opposite to the corresponding third sub-sealant;
wherein each set of die cutting lines comprises a corresponding first sub-cutting line, a corresponding second sub-cutting line, a corresponding third sub-cutting line, and a corresponding fourth sub-cutting line; each first sub-cutting line is close to the corresponding bonding area; and each second sub-cutting line, each third sub-cutting line, and each fourth sub-cutting line are correspondingly disposed corresponding to the corresponding second sub-sealant, the corresponding third sub-sealant, and the corresponding fourth sub-sealant;
wherein an orthographic projection of each first sub-cutting line on the plane where the display panels are located is located outside an orthographic projection of the corresponding first sub-sealant on the plane where the display panels are located;
wherein an orthographic projection of each second sub-cutting line on the plane where the display panels are located is located inside an orthographic projection of the corresponding second sub-sealant on the plane where the display panels are located;
wherein an orthographic projection of a corresponding portion of each third sub-cutting line corresponding to the orthographic projection third sub-sealant on the plane where the display panels are located is located inside an orthographic projection of the corresponding third sub-sealant on the plane where the display panels are located; and
wherein an orthographic projection of a corresponding portion of each fourth sub-cutting line corresponding to the orthographic projection fourth sub-sealant on the plane where the display panels are located is located inside an orthographic projection of the corresponding fourth sub-sealant on the plane where the display panels are located.

7. The LCD motherboard structure of claim 6, wherein each second sub-cutting line divides the corresponding second sub-sealant into a corresponding second outer sub-sealant and a corresponding second inner sub-sealant; each third sub-cutting line divides the corresponding third sub-sealant into a corresponding third outer sub-sealant and a corresponding third inner sub-sealant; and each fourth sub-cutting line divides the corresponding fourth sub-sealant into a corresponding fourth outer sub-sealant and a corresponding fourth inner sub-sealant; and
wherein all of the second outer sub-sealants, the third outer sub-sealants, and the fourth outer sub-sealants have a first predetermined width; and the second inner sub-sealants, the third inner sub-sealants, and the fourth inner sub-sealants have a plurality of corresponding widths all larger than the first predetermined width.

8. The LCD motherboard structure of claim 6, wherein the flexible display motherboard is provided with a corresponding bonding area cutting line for cutting to form the corresponding bonding area of the corresponding array substrate of each display panel; and each third sealant is disposed between the corresponding bonding area cutting line and the corresponding first sub-cutting line.

9. The LCD motherboard structure of claim 8, wherein each display panel is further provided, on a side of the corresponding color filter substrate of each display panel, with a corresponding edge cutting line; and the corresponding edge cutting line is for removing a corresponding portion of the corresponding single color filter substrate of each display panel corresponding to the corresponding bonding area, to expose the corresponding bonding area.

10. The LCD motherboard structure of claim 5, wherein the flexible display motherboard is provided with a set of peripheral cutting lines; the set of peripheral cutting lines divides the flexible display motherboard into a peripheral area and an internal area for the display panels to be disposed therein; and the peripheral area is disposed surrounding the internal area; and
wherein the flexible display motherboard further comprises a second sealant; and an orthographic projection of the set of peripheral cutting lines on the plane where the flexible display motherboard is located is located inside an orthographic projection of the second sealant on the plane where the flexible display motherboard is located.

11. A method for cutting a liquid crystal display (LCD) motherboard structure, comprising:
providing a first rigid substrate and a second rigid substrate, forming a plurality of color filter substrates on the first rigid substrate, and forming a plurality of array substrates on the second rigid substrate;
coating the color filter substrates or the array substrates with a plurality of corresponding first sealants, and bonding the color filter substrates and the corresponding array substrates with the corresponding first sealants, to form a flexible display motherboard, wherein the flexible display motherboard comprises a plurality of display panels; the flexible display motherboard is provided with a set of peripheral cutting lines, a plurality sets of die cutting lines, a plurality of bonding area cutting lines, and a plurality of edge cutting lines; the set of peripheral cutting lines divides the flexible display motherboard into a peripheral area and an internal area for the display panels to be disposed therein; the corresponding set of die cutting lines is for cutting to form each single display panel of the display panels; an orthographic projection of a corresponding portion of each set of die cutting lines on a plane where the display panels are located is located inside an orthographic projection of the corresponding first sealant on the plane where the display panels are located; the corresponding bonding area cutting line is for cutting to form a corresponding bonding area of a corresponding single array substrate of each display panel; and the corresponding edge cutting line is for removing a corresponding portion of the corresponding single color filter substrate of each display panel corresponding to the corresponding bonding area, to expose the corresponding bonding area;
cutting the LCD motherboard structure along the set of peripheral cutting lines, to remove the peripheral area of the flexible display motherboard;
performing laser separation on the flexible display motherboard, to remove the first rigid substrate and the second rigid substrate;
cutting the flexible display motherboard along the corresponding set of die cutting lines, to obtain a corresponding initial display panel for each display panel;
attaching a corresponding polarizer film to each initial display panel;
cutting the corresponding array substrate and the corresponding color filter substrate of each display panel along the corresponding bonding area cutting line at the same time, and cutting the corresponding color filter substrate of each display panel along the corresponding edge cutting line, to form a corresponding further display panel for each display panel; and
bonding a corresponding circuit board to the corresponding bonding area of each further display panel, to form a corresponding flexible LCD panel.

12. The method for cutting the LCD motherboard structure of claim 11, wherein each display panel comprises a corresponding bonding area; each first sealant comprises a corresponding first sub-sealant, a corresponding second sub-sealant, a corresponding third sub-sealant, and a corresponding fourth sub-sealant; each first sub-sealant is close to the corresponding bonding area; each second sub-sealant is opposite to the corresponding first sub-sealant; each third sub-sealant connects the corresponding first sub-sealant to the corresponding second sub-sealant on a same side of the corresponding first sub-sealant and the corresponding second sub-sealant; and each fourth sub-sealant is opposite to the corresponding third sub-sealant;
wherein each set of die cutting lines comprises a corresponding first sub-cutting line, a corresponding second sub-cutting line, a corresponding third sub-cutting line, and a corresponding fourth sub-cutting line; each first sub-cutting line is close to the corresponding bonding area; and each second sub-cutting line, each third sub-cutting line, and each fourth sub-cutting line are correspondingly disposed corresponding to the corresponding second sub-sealant, the corresponding third sub-sealant, and the corresponding fourth sub-sealant;
wherein an orthographic projection of each first sub-cutting line on the plane where the display panels are located is located outside an orthographic projection of the corresponding first sub-sealant on the plane where the display panels are located;
wherein an orthographic projection of each second sub-cutting line on the plane where the display panels are located is located inside an orthographic projection of the corresponding second sub-sealant on the plane where the display panels are located;
wherein an orthographic projection of a corresponding portion of each third sub-cutting line corresponding to the orthographic projection third sub-sealant on the plane where the display panels are located is located inside an orthographic projection of the corresponding third sub-sealant on the plane where the display panels are located; and
wherein an orthographic projection of a corresponding portion of each fourth sub-cutting line corresponding to the orthographic projection fourth sub-sealant on the plane where the display panels are located is located inside an orthographic projection of the corresponding fourth sub-sealant on the plane where the display panels are located.

13. The method for cutting the LCD motherboard structure of claim 12, wherein each second sub-cutting line divides the corresponding second sub-sealant into a corresponding second outer sub-sealant and a corresponding second inner sub-sealant; each third sub-cutting line divides the corresponding third sub-sealant into a corresponding third outer sub-sealant and a corresponding third inner sub-sealant; and each fourth sub-cutting line divides the corresponding fourth sub-sealant into a corresponding fourth outer sub-sealant and a corresponding fourth inner sub-sealant; and
wherein all of the second outer sub-sealants, the third outer sub-sealants, and the fourth outer sub-sealants have a first predetermined width; and the second inner sub-sealants, the third inner sub-sealants, and the fourth inner sub-sealants have a plurality of corresponding widths all larger than the first predetermined width.

14. The method for cutting the LCD motherboard structure of claim 12, further comprising: coating the color filter substrates or the array substrates with a plurality of corresponding third sealants, wherein each third sealant is disposed between the corresponding bonding area cutting line and the corresponding first sub-cutting line.

15. The method for cutting the LCD motherboard structure of claim 11, further comprising: coating the color filter substrates or the array substrates with a second sealant, wherein an orthographic projection of the set of peripheral cutting lines on the plane where the flexible display motherboard is located is located inside an orthographic projection of the second sealant on the plane where the flexible display motherboard is located.
